(19) United States
(12) Patent Application Publication
(10) Pub. No.: US 2008/0277421 A1
(43) Pub. Date: Nov. 13, 2008

(54) Gear pump and foam dispenser

(76) Inventors: Doug Zlatic, North Royalton, OH (US); Mark E. Rosenkranz, Medina, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/801,257

(22) Filed: May 8, 2007

(51) Int. Cl. B67D 5/52; B67D 5/60; B67D 5/40

(52) U.S. Cl. 222/136; 222/145.5; 222/383.2

(57) ABSTRACT

A gear pump for mixing first and second components includes an inlet port, a premix chamber, and a second component valve. The premix chamber has a first end communicating with the inlet port, and a second end communicating with a source of the first component, thus providing a fluid path to carry the first component through the inlet port upon operation of the gear pump. The second component valve regulates fluid communication between a source of the second component and the premix chamber. Upon operation of the gear pump, the first component is drawn from its source into the premix chamber, the second component is drawn from its source, through the second component valve, and into the premix chamber, and a premix of the first and second components is fed from the premix chamber through said inlet port.

### TECHNICAL FIELD

The present invention generally relates to gear pumps, and, more particularly, to gear pumps employed to mix two or more components. In a particular embodiment, this invention relates to a dispenser employing a gear pump to dispense a foam product.

### BACKGROUND OF THE INVENTION

Gear pumps have been used to mix multiple components, as will be seem from a review of the following U.S. Pat. Nos.: 2,324,116; 3,628,893; 3,764,238; 4,059,714; 4,193,745; 4,264,214 and 4,601,645. Although these various patents disclose gear pumps that mix two components, it is significant to note that they mix those components within the housing for the gears of the gear pump. In accordance with the present invention, a gear pump is provided wherein two components are mixed otherwise than only within the housing that holds the gears. Specific embodiments are directed toward the dispensing of foam products for skin care and skin sanitizing, but this invention will have wider application to the mixing of any components suitable for being pumped in accordance with the teaching herein.

With respect to the dispensing of skin care and skin sanitizing products, in the current state of the art, it is common to provide dispensers wherein a permanent housing is provided to receive disposable refill units that include a suitable skin care or skin sanitizing liquid container with associated pump mechanisms. The refill units are received in permanent housings, which provide elements for actuating the pump mechanism provided by the refill unit. When the container of the refill unit is empty, it is simply replaced with a new refill unit. The pump mechanisms in these refill units are of various types, including, most commonly, piston-type and diaphragm-type pumps and, less commonly, gear pumps (as in U.S. Pat. No. 5,836,482). In at least the skin care and skin sanitizer dispensing arts, the diaphragm-type pumps are also commonly known as “dome pumps.” The piston-type and diaphragm-type pumps have been adapted to produce a foam product. However, the gear pumps employed in dispenser refill units have not been adapted to produce a foam product, and the present invention addresses this need in the dispensing arts, while more broadly providing pump and dispenser mechanisms suitable for dispensing virtually any suitable component or components.

### SUMMARY OF THE INVENTION

This invention provides a gear pump for mixing first and second components. The gear pump includes an inlet port, a premix chamber, and a second component valve. The premix chamber has a first end communicating with the inlet port, and a second end communicating with a source of the first component, thus providing a fluid path to carry the first component through the inlet port upon operation of the gear pump. The second component valve regulates fluid communication between a source of the second component and the premix chamber. Upon operation of the gear pump, the first component is drawn from its source into the premix chamber, the second component is drawn from its source, through the second component valve, and into the premix chamber, and a premix of the first and second components is fed from the premix chamber through said inlet port.

In accordance with another embodiment, this invention provides a dispenser that includes a housing that retains a refill unit. The housing has a motor mounted thereto, and the motor provides an output shaft that rotates upon operation of the motor. The refill unit includes a first component container and a gear pump. The first component container retains a first component for dispensing. The gear pump includes a pump housing and has a first gear retained in the pump housing, the first gear having an axis of rotation and radially extending teeth. The output shaft of the motor engages the first gear to rotate the first gear upon operation of the motor. A second gear is retained in the pump housing, the second gear having an axis of rotation and radially extending teeth, wherein the radially extending teeth of the first gear intermesh with the radially extending teeth of the second gear at a nip such that rotation of the first gear effects the rotation of the second gear. During such rotation, the radially extending teeth of the first and second gears engage to intermesh on one side of the nip and disengage from intermeshing on the other side of the nip. An inlet port communicates with the pump housing on the side of the nip where the radially extending teeth of the first and second gears disengage from intermeshing, and an outlet port communicates with the pump housing on the side of the nip where the radially extending teeth of the first and second gears engage to intermesh. The refill unit also includes a premix chamber having a first end communicating with the housing, through the inlet port, and a second end communicating with the first component retained within the first component container, thus providing a fluid path to carry the first component into the pump housing. The refill unit also includes a second component valve regulating fluid communication between a second component and the fluid path of the premix chamber. Upon rotation of the first and second gears, the first component is drawn through the fluid path of the premix chamber and the second component is drawn through the second component valve into the fluid path and a premix of the first and second components is fed to the pump housing through the inlet port.

### BRIEF DESCRIPTION OF DRAWINGS

For a complete understanding of the objects, techniques and structure of the invention, reference should be made to the following detailed description and accompanying drawings wherein:

FIG. 1 is a perspective view of a dispenser in accordance with this invention, including a refill unit that carries a gear pump in accordance with this invention;

FIG. 2 is side elevation of the general components of a refill unit in accordance with this invention;

FIG. 3 is a cross sectional view of the refill unit mated to a motor in the dispenser, wherein the cross section is taken through the center of the drive gear of the gear pump and jogs to extend through the center of the dip tube and dispensing tube;

FIG. 3A is an exploded view of the portion identified as FIG. 3A in FIG. 3;

FIG. 4 is a cross sectional view of the refill unit, taken through the line 4--4 in FIG. 2, with the foam adjustment valve portion of the gear pump shown opened;

FIG. 5 is a close up view of the foam adjustment valve portion of the gear pump, shown closed; and

FIG. 6 is a general schematic of an alternative dispensing system wherein two liquid components and air are drawn to into and dispensed from a common gear pump.

### DETAILED DESCRIPTION OF THE PREFERRED EMBODIMENTS

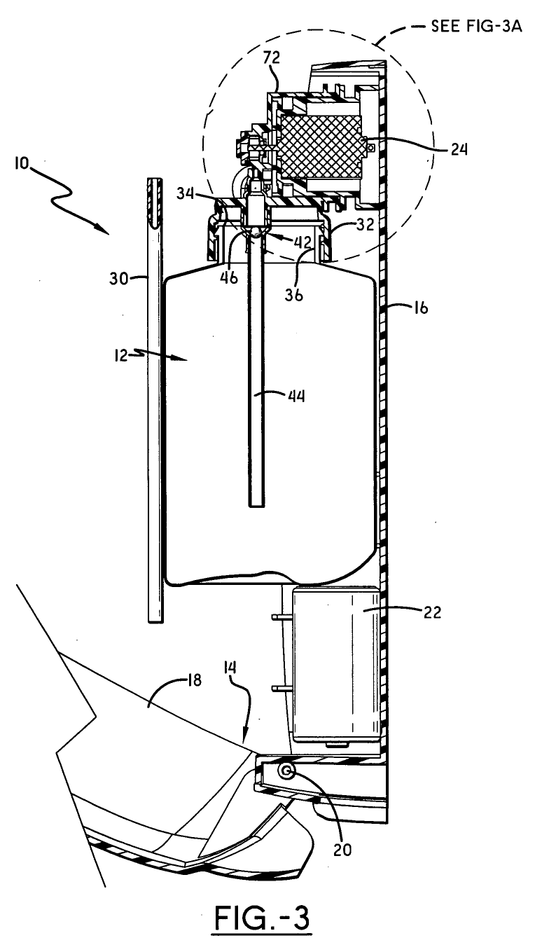

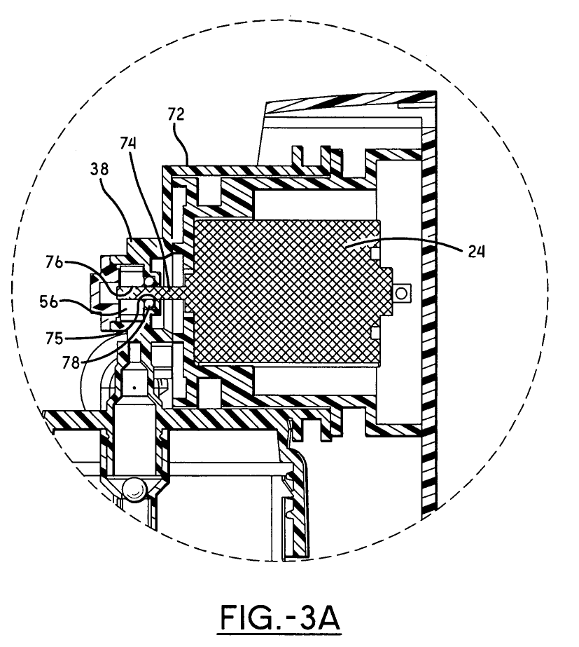

Referring now to FIGS. 1-3 and 3A, a dispenser in accordance with this invention is shown and designated by the numeral 10. The dispenser 10 includes a refill unit 12 that is selectively received within a dispenser housing 14 having a backplate 16 and cover 18. As seen, and as generally known, cover 18 is secured to backplate 16 at a hinge 20 (FIG. 3) such that cover 18 can pivot between an open position, wherein a refill unit 12 can be placed within the dispenser housing 14, and a closed position, wherein a refill unit 12 may be retained in the dispenser housing 14 and be ready for use. Backplate 16 may include any well known structure for receiving batteries 22 and communicating their power to operate a motor 24. Any other suitable power source could be used as well. The motor 24 is used to advance gears of a gear pump assembly 26 of the refill unit 12. The refill unit 12 includes the gear pump assembly 26 and the container 28 to which it is secured. The container holds a foamable liquid S, and advancement of the gears of the gear pump assembly 26 causes the foamable liquid S to be mixed with air to create a foam product that is dispensed through dispensing tube 30.

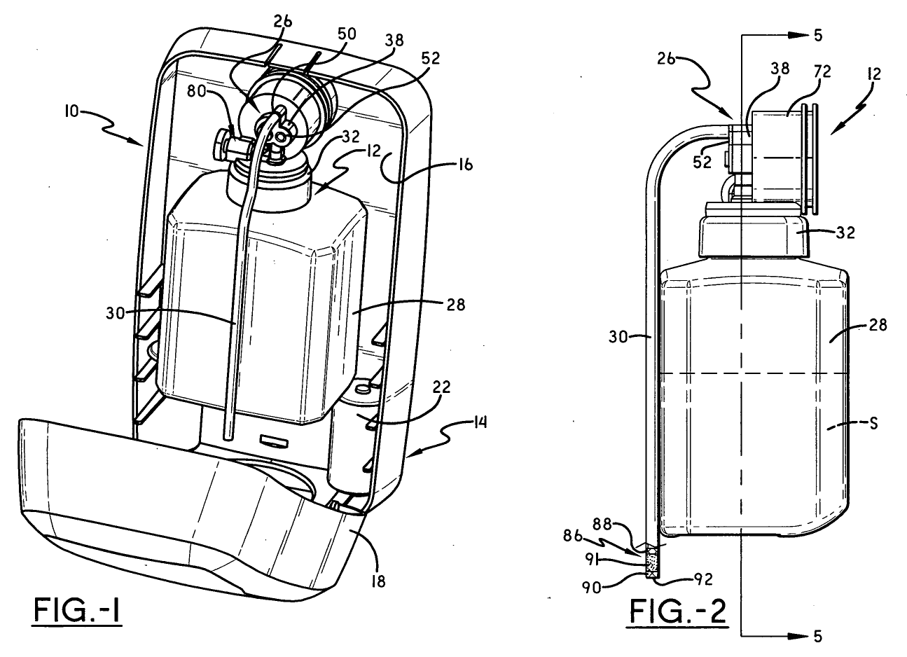

With reference to FIGS. 2-5, the various components of the refill unit 12 are more particularly disclosed. The refill unit 12 includes the container 28 and the gear pump assembly 26. The gear pump assembly 26 includes a neck cap portion 32 that fits over the open end 34 provided at a neck portion 36 of container 28. The fit shown is a snap fit, but others can be employed, such as a threaded fit. A pump housing 38 extends from the neck cap portion 32 and ultimately communicates with the foamable liquid S in the container 28 through a premix chamber 40, a check valve 42, and a dip tube 44. The check valve 42 is shown as a ball valve having a ball 46 that seals off the dip tube 44 in a known manner, and it will be appreciated that other types of check valves could be employed, for example, duck bill valves. The interior of the pump housing 38 communicates with the premix chamber 40 at an inlet port 48 and communicates with the dispensing tube 30 through an outlet port 50 provided in the cover 52 of the pump housing 38.

Pump housing 38 defines a first gear portion 54 that retains a first gear 56, and a second gear portion 58 that retains a second gear 60. The first gear 56 includes radially extending teeth 62 that engage the sidewall 64 of the first gear portion 54. Similarly, the second gear 58 includes radially extending teeth 66 that engage the sidewall 68 of the second gear portion 58. The radially extending teeth 62 and 66 intermesh at nip 70, where the teeth 62, 68 of the first and second gear portions 54, 58 overlap.

The pump housing 38 is associated with, and, in this particular embodiment, is molded as part of a motor mount member 72. A drive shaft 74 extends from the motor 24, through a shaft aperture 75 in the pump housing 38, into the interior of the first gear portion 54 to engage a drive aperture 76 in the first gear 56. The drive shaft 74 engages the drive aperture 76 such that rotation of the drive shaft about its axis also causes rotation of the first gear 56. This can be accomplished in a number of ways and is accomplished in particular embodiments by having a non-circular shape for the drive aperture 76, and a complimentary shape for at least that portion of the drive shaft 74 that extends into the drive aperture 76. The motor mount member 72 is shaped such that it is securely received over the motor 24, as shown. In some embodiments, this engagement can help hold the refill unit 12 to the backplate 16 of the dispenser 10. It also helps to align the drive shaft 74 of the motor 24 with the shaft aperture 75 and the drive aperture 76. In the embodiment shown, the motor mount member 72 fits over the motor 24 and engages it through a snap fit, and, as the motor mount member 72 mates with the motor 24, the drive shaft 74 mates with the drive aperture 76. A seal 78 is provided in the pump housing 38, between the first gear 56 and the pump housing 38, to prevent leaking from pump housing 38 at shaft aperture 75. Once the refill unit 12 is mounted to the dispenser in this manner, the motor 24 can be operated to rotate both first gear 56 and second gear 60, with the second gear 60 being driven due to its intermeshing with the first gear 56 at nip 70. It is the driving of the gears 56, 60 that causes the pumping of foamable liquid and air to create the desired foam product at dispensing tube 30.

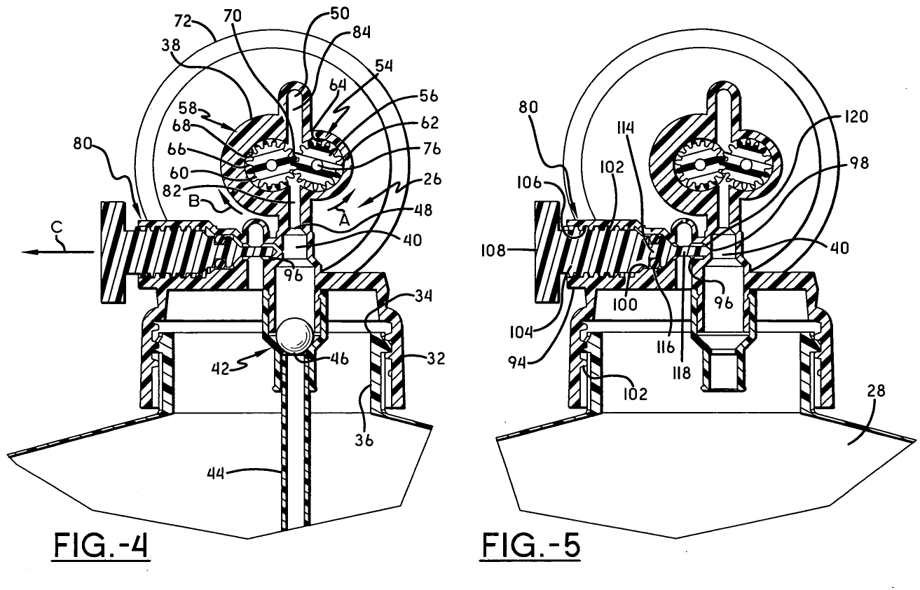

More particularly, as seen in FIG. 4, the first gear 56 is driven in the direction of arrow A and, thus, the second gear 60 is driven in the direction of arrow B. When the gears 56, 60 are driven in this manner, negative pressure is created along the inlet path 82 and at the inlet port 48, because it is along this path that the teeth 62, 66 disengage from their meshing at nip 70. Similarly, positive pressure is created along outlet path 84 and at the outlet port 50, because it is along this path that the teeth 62, 66 engage to intermesh at nip 70. The negative pressure at the inlet port 48 draws the foamable liquid S up the dip tube 44, past the check valve 42 and into the premix chamber 40. Air is also drawn into the premix chamber 40 through a foam adjustment valve 80, which will be explained more fully below. Because both air and a foamable liquid S are drawn into the premix chamber 40, a course premix of air and foamable liquid S is created at the premix chamber 40 and it is this premix that is drawn into the pump housing 38 at the inlet port 48.

The premix is drawn from the inlet port 48, through the inlet path 82, toward the nip 70. As the premix approaches the nip 70, it becomes impounded between adjacent teeth of the first and second gears 56 and 60, and is carried between the teeth and the pump housing 38 to be circumferentially moved from the inlet path 82, where the teeth 62, 66 disengage, to the outlet path 84, where the teeth 62, 66 engage. Positive pressure is created where the teeth engage such that the premix that is moved to the outlet side of the nip 70 is forced through the outlet path 84 to the outlet port 50 communicating with the dispensing tube 30. Thus, as the first gear 56 and the second gear 60 are rotated within their respective first and second gear portions 54, 58, a premixture of air and foamable liquid S is created at the premix chamber 40, from where it is drawn through the gear pump housing 38 and forced out at the outlet port 50.

The premix that is carried between the teeth 62, 66 of the first and second gears 56, 60 is further homogenized at the outlet path 8 4 inasmuch as discreet volumes of the premix held between adjacent teeth are forced into each other at the outlet path 84. In some embodiments, this might create a satisfactory foam product at outlet port 50. In such a case, the dispensing tube 30 could simply be a conduit for the foamed product, and would be of a length suitable for whatever particular dispenser style is practiced. In the present figures, a wall-mounted dispenser has been the focus, but other dispensers, including hand held and counter-mounted types could be practice with the container and pump combination disclosed herein. In other embodiments, the mixing effected at the outlet path 84 may not be sufficient for creating a suitably homogenized foam product, and, in such instances, it is preferred that the dispensing tube 30 include a mixing chamber for homogenizing the foam and producing a desired foam product.

As seen in FIG. 2, such a mixing chamber 86 would include an inlet mesh 88 and an outlet mesh 90, and a premix forced through the mixing chamber 86 would become more homogenized by the action of these two meshes 88, 90 through which it must pass. The volume of the mixing chamber defined between the inlet mesh 88 and the outlet mesh 90 may also be filled with a sponge material 91 in order to help further homogenize the foam product. Notably, the mixing chamber 86 would preferably be placed proximate the outlet 92 of the dispensing tube 30 because it requires less power to advance a premix than it does to advance a homogenized foam product. This may be found to be particularly suitable for wall-mounted dispensers and counter mounted dispensers, wherein the refill unit 12 may be mounted at some distance from the dispenser outlet, thus requiring a dispensing tube 30 of significant length.

The foam adjustment valve 80 is manipulated to adjust the amount of air drawn into the premix chamber 40 during rotation of the gears 56, 60. While virtually any valve that would function appropriately for this purpose could be employed, a particular embodiment is shown in FIGS. 4 and 5. Therein, the foam adjustment valve 80 includes an adjustment valve housing 94 defining an air path 96 that communicates with the premix chamber 40 through an air port 98, and ultimately communicates with a source of air. This source of air could be the air within the container 28 or could be the surrounding atmosphere. In the embodiment shown, the air path 96 communicates with the container 28 to draw air therefrom. In some embodiments, the container is vented, and thus air is drawn into the container 28 through the vent and the container does not collapse. In other embodiments, the container does not include a vent and, as a result, the container 28 collapses as the air and liquid is drawn from the container 28.

The adjustment valve housing 94 also defines a seal chamber 100 and a threaded shaft chamber 102, both of which also communicate with the air path 96 and the air port 98. An adjustment valve shaft 104 mates with the adjustment valve housing 94, and is manipulated to selectively open and close the air port 98 to a greater or lesser degree to permit the passage of more or less air into the premix chamber 40 during rotation of the gears 56, 60. More particularly, a threaded section 106 of the adjustment valve shaft 104 extends from a knob 108, and is threaded to the threaded shaft chamber 102. A seal section 114 of the adjustment valve shaft 104 engages the seal chamber 100 of the adjustment valve housing 94 through an O-ring 116 such that the air path 96 is sealed from the threaded shaft chamber 102. A needle head 118 extends from seal section 114 of the adjustment valve shaft 104, across and through the air path 96, and ends at a valve seat 120. The needle head 118 is sized at least slightly smaller than the air path 96 so that air may flow in air path 96.

As in FIG. 5, the adjustment valve shaft 104 can be manipulated at knob 108 to fully close the foam adjustment valve 80, with the valve seat 120 of needle head 118 intimately contacting the air port 98 that communicates into the premix chamber 40. In this way, no air can be drawn into the premix chamber 40, and the gear pump assembly 36 can thus be made to pump only the liquid within the container 12, without mixing it with air. However, as can be seen in FIG. 4, the adjustment valve shaft 104 can be manipulated at knob 108 to move in the direction of arrow C, thus moving the valve seat 120 of needle head 118 off of the air port 98, and permitting the passage of air through air path 96 into the premix chamber 40. It will be appreciated that the volume of the air path 96 can be adjusted by the movement of the adjustment valve shaft 104. By making the volume of the air path 96 larger, more air would be drawn into the premix chamber 40 during rotation of the gears 56, 60, such that lighter, airy foam would ultimately be produced. By making the volume of the air path 96 smaller, less air would be drawn into the premix chamber 40 during rotation of the gears 56, 60, thus producing heavier, wetter foam. The foam adjustment valve 80 can be manipulated to increase or decrease the amount of air drawn in to the pump mechanisms through the premix chamber 40, and is used to create a foam product of a desired quality.

It should be appreciated that the refill unit 12 shown in the drawings is particularly useful in the wall-mounted dispenser embodiment of dispenser 10 (FIGS. 1 and 3), but the general structures and concepts disclosed herein could be applied to hand held dispensers and counter-mounted dispensers. In a hand held embodiment, the refill unit 12 would simply be constructed so as to produce a sleek external appearance and would carry a motor that is selectively activated for advancing the gears of the pump. In a counter-mounted environment, the structural elements of the refill unit could be readily adapted to be mounted to a motor below a counter, with the dispensing tube extending through the counter to present the product outlet over a sink basin.

If the drive shaft 74 is continuously driven, the foamable liquid and air components will be continuously drawn into and expelled out of the gear pump assembly 26. While this may be appropriate in some applications, it is envisioned that, in some embodiments, as, for instance, in the creation of a foam soap, only “doses” of the end product will be desired. When this is the case, the drive shaft 76 is preferably only driven for a time sufficient to expel a desired dose of the mixed product. The time that the drive shaft 76 will have to be driven will depend upon the desired dose of the mixed product and the flow through rate for the gear pump assembly 26.

In a foam soap embodiment using foamable liquid soap, the foam adjustment valve is adjusted such that the ratio of air to liquid soap drawn into the pump housing is from 30:1 to 3:1. In a particular embodiment the ratio maybe 20:1 to 5:1, and in other embodiments from 12:1 to 8:1.

It should be appreciated that the refill units taught herein could be employed in various dispensers for supplying various mixed products, whether those products are simple single component products (when the air inlet at the foam adjustment valve is closed) or foam products of liquid and air mixtures or mixtures of two liquid components, either with or without air incorporated therein (a liquid/liquid mixture is discussed below). Thus, a particular refill unit might be provided having a particular component therein, and such refill units will be particular to a given desired application. In such a situation, it will be important to avoid inserting a particular refill unit into a dispenser that is designated for a different refill unit. For example, it would be important to avoid inserting a hand soap refill unit into a hand sanitizer dispenser. Therefore, the refill units and dispenser housings of this invention could optionally be provided with physical or electronic keying systems to either prevent the loading of an improper refill unit into a given dispenser or allow the loading, but prevent dispensing. A physical or electronic keying system would be established between a given dispenser and a given refill unit. If the key on the refill unit does not match up with the key on a dispenser housing, then either loading of the refill unit or dispensing of the product would be prohibited.

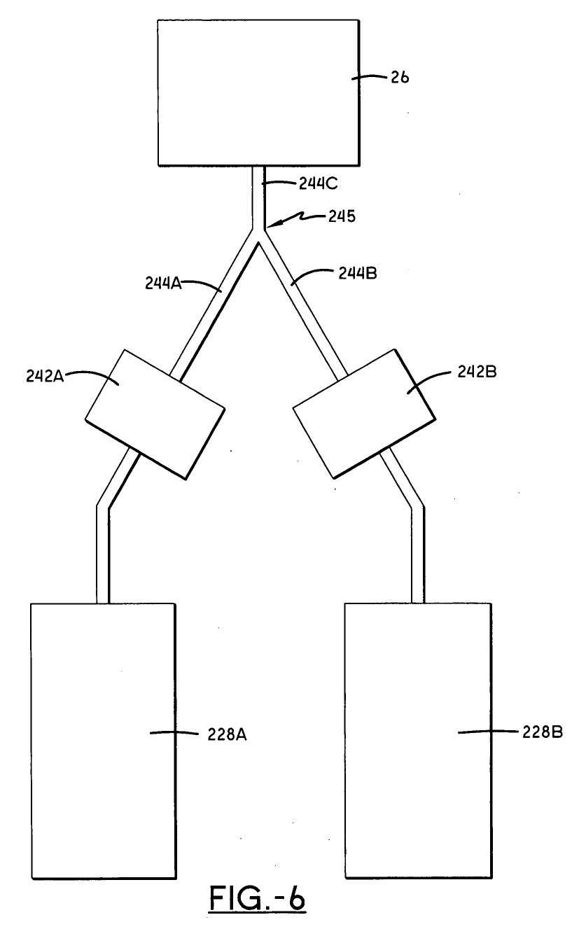

In accordance with the teaching herein, it should be appreciate that this invention need not be limited to the mixing of a single liquid component with air. Other gases could be introduced at foam adjustment valve 80, simply by associating that valve with a particular gas source. Also, as generally represented in FIG. 6, multiple liquid sources could be drawn to a common gear pump assembly 26. Particularly, an alternative unit 212, includes a first component container 228A and a second component container 228B, both of which communicate with a gear pump assembly 26 through respective dip tubes 244A and 244B that join at junction 245 to form a single dip tube 244C communicating with gear pump assembly 26 as disclosed with respect to dip tube 44. The gear pump assembly includes a premix chamber, an adjustment valve, gears, inlet and outlet, as already disclosed. Upon operation of this gear pump assembly 26, a first component is drawn from first component container 228A, through check valve 242A, and a second component is drawn from second component container 228B, through check valve 242B. These components mix at dip tube 244C, and thereafter are drawn into and through the gear pump assembly as already disclosed, with a third component being selectively introduced at the gear pump assembly, as already disclosed with respect to adjustment valve 80 and premix chamber 40. It should be appreciated that where the two components are reactive upon contact, it would be preferable to join the components directly before the gear pump to minimize reaction and residue in the dip tubes 244A, 244B, and 244C.

It should also be appreciated that, although this invention provides advances in mixing multiple components within a gear pump, gear pumps are generally known. This invention has provided specific embodiments employing external gear pump designs, but it should be appreciated that the teachings herein may be followed with internal gear pump designs as an alternative.

It is a common problem with foam dispensers that they might drip when the foam product breaks down back to its liquid component or components. This is particularly true when the outlet of the dispenser points downwardly, because simple gravity will cause the liquid component to drip out of the outlet. The present invention can be used to counteract this dripping by reversing the motor for a short time after a given product dispensing. The reversal of the motor will result in a reversing of the areas of positive and negative pressure in the pump assembly (i.e., during reversal, the teeth will part where they usually join during dispensing, and will join where they usually part during dispensing), and this will cause a reversal of product flow, thus pulling foam product back from the outlet. The extent to which the motor is reversed will depend upon how far back the product must be pulled to prevent dripping. For example, in the embodiment shown in FIG. 1, the reversal should be sufficient to pull foam product back past all of the downwardly directed dispensing tube length.

In light of the foregoing, it should thus be evident that the present invention provides a gear pump and foam dispenser that substantially improves the art. In accordance with the patent statutes, only the preferred embodiments of the present invention have been described in detail hereinabove, but this invention is not to be limited thereto or thereby. Rather, the scope of the invention shall include all modifications and variations that fall within the scope of the attached claims.

What is claimed is:

1. A gear pump for mixing first and second components comprising:
an inlet port;
a premix chamber having a first end communicating with said inlet port, and a second end communicating with a source of the first component, thus providing a fluid path to carry the first component through the inlet port upon operation of the gear pump; and
a second component valve regulating fluid communication between a source of the second component and said premix chamber, wherein, upon operation of the gear pump, the first component is drawn from said source of the first component into said premix chamber, the second component is drawn from the source of the second component, through said second component valve, and into said premix chamber, and a premix of the first and second components is fed through said inlet port.

2. The gear pump of claim 1, wherein said second component valve is adapted for manipulation to adjust the amount of the second component drawn into said premix chamber during operation of the gear pump.

3. The gear pump of claim 1, wherein the second component is a gas.

4. The gear pump of claim 3, wherein the second component is air, and the source of said second component is the ambient atmosphere.

5. The gear pump of claim 3, wherein the second component is air, and the source of said second component is air retained in the source of the first component.

6. The gear pump of claim 3, wherein the first component is liquid soap.

7. The gear pump of claim 3, wherein the first component is a hand sanitizer.

8. The gear pump of claim 1, wherein the second component valve includes a valve housing that communicates with said premix chamber through a valve port.

9. The gear pump of claim 8, wherein the second component valve further includes a valve shaft that mates with the valve housing, and is adapted for manipulation to selectively open and close the valve port to a greater or lesser degree to permit the passage of more or less of the second component into said premix chamber during operation of the gear pump.

10. A dispenser comprising:
a housing having a motor mounted thereto, said motor having an output shaft that rotates upon operation of the motor;
a refill unit including:
a first component container retaining a first component;
a gear pump having:
a pump housing,
a first gear retained in said pump housing and having an axis of rotation and radially extending teeth, said output shaft of said motor engaging said first gear to rotate said first gear upon operation of the motor;
a second gear retained in said pump housing and having an axis of rotation and radially extending teeth, wherein the radially extending teeth of the first gear intermesh with the radially extending teeth of the second gear at a nip such that rotation of said first gear effects the rotation of said second gear, the radially extending teeth of said first and second gears engage to intermesh on one side of said nip and disengage from intermeshing on the other side of said nip;
an inlet port communicating with said pump housing on the side of the nip where said radially extending teeth of said first and second gears disengage from intermeshing; and
an outlet port communicating with said pump housing on the side of the nip where said radially extending teeth of said first and second gears engage to intermesh;
a premix chamber having a first end communicating with said pump housing, through said inlet port, and a second end communicating with the first component retained within said first component container, thus providing a fluid path to carry said first component into said pump housing; and
a second component valve regulating fluid communication between a second component and said fluid path of said premix chamber, wherein, upon rotation of said first and second gears, said first component is drawn through said fluid path of said premix chamber and said second component is drawn through said second component valve into said fluid path and a premix of said first and second components is fed to said pump housing through said inlet port.

11. The gear pump of claim 10, wherein said second component valve is adapted for manipulation to adjust the amount of the second component drawn into said premix chamber during operation of the gear pump.

12. The gear pump of claim 10, wherein the second component is a gas.

13. The gear pump of claim 12, wherein the second component is air, and the source of said second component is the ambient atmosphere.

14. The gear pump of claim 12, wherein the second component is air, and the source of said second component is air retained in the source of the first component.

15. The gear pump of claim 10, wherein the second component valve includes a valve housing that communicates with said premix chamber through a valve port.

16. The gear pump of claim 15, wherein the second component valve further includes a valve shaft that mates with the valve housing, and is adapted for manipulation to selectively open and close the valve port to a greater or lesser degree to permit the passage of more or less of the second component into said premix chamber during operation of the gear pump.
